(19) United States
(12) Patent Application Publication
(10) Pub. No.: US 2024/0420133 A1
(43) Pub. Date: Dec. 19, 2024

(54) METHODS, SYSTEMS, AND COMPUTER PROGRAM PRODUCTS FOR TRANSFER VALIDATION

(71) Applicant: Wells Fargo Bank, N.A., San Francisco, CA (US)

(72) Inventor: Karthik Dappuri, Hyderabad (IN)

(21) Appl. No.: 17/644,848

(22) Filed: Dec. 17, 2021

(51) Int. Cl. G06Q 20/40; G06N 5/02

(52) U.S. Cl. CPC G06Q 20/401; G06N 5/022

(57) ABSTRACT

Various embodiments of the present disclosure provide methods, apparatuses, systems, computing devices, and/or the like that are configured to train a wire transfer validation machine learning model to process transfer requests to a potential recipient. An example computer-implemented method includes receiving the transfer request that includes data entries associated with scannable indicia indicative of a recipient of the transfer request. The method includes applying, for the transfer request, a wire transfer validation machine learning model to determine a transfer validation prediction object for the transfer request and generating a wire transfer validation interface based on the transfer validation prediction object. The wire transfer validation interface may include an actionable object configured to complete a real-time transfer from a user account associated with the transfer request to a recipient account as indicated by the scannable indicia of the transfer request.

### TECHNOLOGICAL FIELD

Example embodiments of the present disclosure relate generally to machine learning based validation of wire transfers.

### BACKGROUND

Financial institutions and other entities often collect or otherwise have access to a large amount of data, including data associated with particular users, transactions, and the like. By way of example, these entities may collect, store, and analyze data associated with wire transfers between users, businesses, etc. In some instances, however, these transfers may be fraudulent in that the funds are incorrectly provided to and/or received from a fraudulent entity or user.

### BRIEF SUMMARY

As described above, financial institutions and other entities collect, store, and analyze user data of many types and from many sources. In the context of a financial institution, for example, data may be collected associated with various payments or transactions, such as data associated with or indicative of wire transfers (e.g., Society for Worldwide Interbank Financial Telecommunication (SWIFT) transaction, Federal Reserve Wire Network transactions, Clearing House Interbank Payments System transactions, or the like). In some instances, these wire transfers may be fraudulent in that an incorrect (e.g., fraudulent) entity receives the funds associated with the transfer as opposed to the intended recipient. For example, a bad actor, wire fraud scam, or fraudulent entity may attempt to divert, redirect, or otherwise cause funds from a user's account to be provided to an unintended recipient. By way of a particular example, fraudulent entities associated with particular geographic locations, industries, account numbers, etc. may spoof or otherwise imitate legitimate account numbers, users (e.g., recipients), payments, etc. in order to attempt to receive funds from legitimate users. Given that wire transfers are often processed in substantially real-time, the ability to detect the fraudulent attempts and/or to retroactively address fraudulent transactions by conventional systems is substantially limited.

To solve these issues and others, example implementations of embodiments of the present disclosure may generate and leverage a wire transfer validation server, server, or computing device in which a likelihood of fraudulent activity by a potentially fraudulent receiving entity (e.g., a potential fraudulent entity) of the wire transfer in order to mitigate the likelihood of a wire transfer being transmitted to a fraudulent entity or fraudulent person. The wire transfer validation server may use such data to train one or more machine learning models and/or one or more natural language processors (NLP) to determine a likelihood of a fraudulent receiving activity based on a determination regarding a request for a wire transfer received in real-time by the wire transfer validation server. Such a wire transfer validation server may be trained on a robust network of data including such data obtained from one or more financial institutions and/or data obtained and parsed from one or more data sources discussing scam or fraud activities of potential recipients. Furthermore, the embodiments of the present disclosure may utilize these models to examine transaction data that includes emerging technologies for providing user data, such as data acquired from scannable indicia (e.g., Quick Response (QR) codes) and data acquired from NLP.

In this way, the inventors have identified that the advent of computing resources have created a new opportunity for solutions for transactions and associated fraud detection which were historically unavailable. In particular, the embodiments herein may operate to address several technical challenges including: (1) generating machine learning model(s) for accurately predicting potential sources for transaction fraud and (2) identifying potential fraudulent transactions based upon scannable indicia and/or NLP.

Systems, apparatuses, methods, and computer program products are disclosed herein for transfer validation. In one embodiment with reference to an example method, a computer-implemented method for generating a transfer validation is provided that includes receiving a transfer request where the transfer request includes one or more data entries associated with scannable indicia indicative of a recipient of the transfer request. The method may further include applying, for the transfer request, a wire transfer validation machine learning model to determine a transfer validation prediction object for the transfer request and generating a wire transfer validation interface based on the transfer validation prediction object. The wire transfer validation interface may include an actionable object configured to complete a real-time transfer from a user account associated with the transfer request to a recipient account associated the recipient as indicated by the scannable indicia.

In some embodiments, the computer-implemented method may further include training the wire transfer validation machine learning model using a training protocol. Implementation of this protocol may include collecting a set of wire transfers from a database, extracting one or more identifiers from the set of wire transfers to create a training set of wire transfers. The training set of wire transfers may include a score identifier based on at least one of a recipient identifier, a location identifier, or an account identifier and training the wire transfer validation machine learning model may use the training set of wire transfers.

In some embodiments, the computer-implemented method may further include collecting a second set of wire transfers from the database over a second time period and extracting one or more identifiers from the second set of wire transfers to create a second training set of wire transfers. As such, the method may further include training the wire transfer validation machine learning model using the second training set of wire transfers.

In some embodiments, the computer-implemented method may further include applying a meta score to the transfer validation prediction object associated with the transfer request.

In some embodiments, the computer-implemented method may further include assigning the meta score associated with the transfer request to the score identifier of the training set of wire transfers to create an updated score identifier associated with at least one of the recipient identifier, the location identifier, or the account identifier.

In some further embodiments, the computer-implemented method may further include modifying, in response to the determination that the meta score satisfies the threshold score, the wire transfer validation interface to provide an alert associated with the transfer validation prediction object to indicate the meta score and request an input by a user associated with the user account to complete the transfer request.

In some embodiments, the computer-implemented method may further include collecting a set of wire transfer reports from one or more report databases, extracting one or more report data objects from the set of wire transfer reports, and parsing the one or more report data objects using a natural language processor (NLP) to determine the score identifier.

In some embodiments, the computer-implemented method may further include comparing the meta score of the transfer validation prediction object with a threshold score. The meta score may be determined by the transfer validation prediction object associated with the transfer request. The method may further include determining that the meta score satisfies the threshold score.

In some embodiments, the computer-implemented method may further include transmitting, in response to the determination the meta score satisfies the threshold score, a transfer from the user account associated with the transfer request to the recipient account as indicated by the scannable indicia of the transfer request.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates a system diagram including devices that may be involved in some example embodiments described herein.

FIG. 2 illustrates a schematic block diagram of example wire transfer validation server circuitry that may perform various operations, in accordance with some example embodiments described herein.

FIG. 3 illustrates a schematic block diagram of example device circuitry that may perform various operations, in accordance with some example embodiments described herein.

FIG. 4 illustrates an example flowchart for example wire transfer validation server operations, in accordance with some example embodiments described herein.

FIG. 5 illustrates an example flowchart for training a wire transfer validation machine learning model of the wire transfer validation server, in accordance with some example embodiments described herein.

FIG. 6 illustrates an example flowchart for training a wire transfer validation machine learning model of the wire transfer validation server using a second set of wire transfers, in accordance with some example embodiments described herein.

FIG. 7 illustrates an example flowchart for training a wire transfer validation machine learning model of the wire transfer validation server using a set of wire transfer reports, in accordance with some example embodiments described herein.

FIG. 8 illustrates an example flowchart for applying a meta score to a transfer validation prediction object generated by the wire transfer validation server for determination of a fraudulent wire transfer, in accordance with some example embodiments described herein.

### DETAILED DESCRIPTION

Some embodiments of the present disclosure will now be described more fully hereinafter with reference to the accompanying drawings, in which some, but not all embodiments are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout. As used herein, the description may refer to a wire transfer validation server as an example “apparatus” or “computing device.” However, elements of the apparatus described herein may be equally applicable to the claimed method and computer program product. Thus, use of any such terms should not be taken to limit the spirit and scope of embodiments of the present disclosure.

### Definitions of Terms

As used herein, the terms “data,” “content,” “information,” “electronic information,” “signal,” “command,” and similar terms may be used interchangeably to refer to data capable of being transmitted, received, and/or stored in accordance with embodiments of the present disclosure. Thus, use of any such terms should not be taken to limit the spirit or scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, remote servers, cloud-based servers (e.g., cloud utilities), relays, routers, network access points, base stations, hosts, and/or the like.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the word “example” is used to mean “serving as an example, instance, or illustration.” Any implementation described herein as “example” is not necessarily to be construed as preferred or advantageous over other implementations.

As used herein, the terms “client device,” “recipient device,” “user device,” “mobile device,” “electronic device” and the like refer to computer hardware that is configured (either physically or by the execution of software) to access one or more servers made available by a wire transfer validation server, and is configured to directly, or indirectly, transmit and receive data. Example client devices may include a smartphone, a tablet computer, a laptop computer, a wearable device (e.g., smart glasses, smart watch, or the like), and the like. In some embodiments, a client device may include a “smart device” that is equipped with a chip or other electronic device that is configured to communicate with the apparatus via Bluetooth, NFC, Wi-Fi, 3G, 4G, 5G, RFID protocols, and the like. By way of a particular example, a client device may be a mobile phone equipped with a Wi-Fi radio that is configured to communicate with a Wi-Fi access point that is in communication with the wire transfer validation server 200 or other computing devices via a network. Example recipient devices may similarly include a smartphone, a tablet computer, a laptop computer, a wearable device (e.g., smart glasses, smart watch, or the like), and the like. In some embodiments, a recipient device may include a “smart device” that is equipped with a chip or other electronic device that is configured to communicate with the apparatus via Bluetooth, NFC, Wi-Fi, 3G, 4G, 5G, RFID protocols, and the like. By way of a particular example, a recipient device may be a mobile phone equipped with a Wi-Fi radio that is configured to communicate with a Wi-Fi access point that is in communication with the wire transfer validation server 200 or other computing devices via a network 101.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM), and the like.

The term “transfer request” refers to a data object that is configured as information, text, and/or other media used to describe the request of a user, of the wire transfer validation server, to transmit a wire transfer to a recipient. Such a transfer request may be embodied by a data object (or plurality of data objects) describing the item to be transferred by the wire transfer. Such items associated with a wire transfer may comprise a valuation (e.g., dollar amount for transfer from a user to a recipient), identifying information of the recipient and/or the user (e.g., account data, user identification data, etc.), documents for transfer from a user to a recipient, and/or other sensitive data of the user and/or recipient for transfer from a user to a recipient by the wire transfer.

As used herein, the term “wire transfer validation server” refers to computer hardware that is configured (either physically or by the execution of software) to monitor received transfer requests (e.g., transfer requests associated with wire transfers), determine a transfer validation prediction object using a trained machine learning model (e.g., wire transfer validation machine learning model(s)), and/or effectuate a transaction with a user as described hereafter, and, among various other functions, is configured to directly, or indirectly, transmit and receive data. An example wire transfer validation server may include or comprise various computing devices including a smartphone, a tablet computer, a laptop computer, a central server, a remote server, a wearable device (e.g., smart glasses, smart watch, or the like), and the like. In some embodiments, the wire transfer validation server may include a “smart device” that is equipped with a chip or other electronic device that is configured to communicate with a client devices, recipient devices, and/or databases via Bluetooth, NFC, Wi-Fi, 3G, 4G, 5G, RFID protocols, and the like. By way of a particular example, a wire transfer validation server of the present disclosure may be a computing device embodied as a centralized server of an example financial institution with which user devices may transact.

The term “scannable indicia” refers to a data object comprising one or more properties readable by a computing device via imaging methods, image processing, or the like (e.g., scanning, image capture, etc.). Such scannable indicia may include a QR code, a barcode, or other such computer-readable formats such that an imaging device (e.g., camera, imager, etc.) may capture one or more images of the scannable indicia and receive data provided by the scannable indicia. By way of example, a camera communicably coupled with one or more computing devices of the present disclosure may capture images of a QR code and receive QR code data indicative of a recipient of an example wire transfer.

The term “actionable object” refers to a selectable input on a graphical user interface (GUI) configured for input by a user and/or client (e.g., user of the wire transfer validation server) on a client device, user device, etc. Such actionable object may comprise a configured GUI comprising “buttons” indicating input by the user of the client device, such as by use of a physical button on the client or user device or by a touch-screen button on the client or device.

The term “wire transfer validation machine learning model” refers to a machine learning model that is trained and otherwise configured to receive transfer requests of a wire transfer validation server and generate wire transfer validation predictions. The configuration data for the one or more wire transfer validation machine learning models may be stored in a storage subsystem associated with the wire transfer validation server. The wire transfer validation machine learning model may be trained using one or more sets of wire transfers (e.g., a set of wire transfers, a second set of wire transfers, a third set of wire transfers, a fourth set of wire transfers, etc.) which may be used to create a training set of wire transfers. Once the wire transfer validation machine learning model has been trained, the wire transfer validation machine learning model may process one or more transfer requests generated by the wire transfer validation server based upon one or more inputs by a user or user device, such as via the wire transfer validation server. Such a trained wire transfer validation machine learning model may output a transfer validation prediction (e.g., a transfer validation prediction object) to a wire transfer validation interface (e.g., an interface generated by the wire transfer validation server). Such example wire transfer validation machine learning models may comprise a Natural Language Processor (NLP), a Convolutional Neural Network (CNN) and/or a Deep Neural Network (DNN). For example, a DNN may be used as the wire transfer validation machine learning model, wherein two or more wire transfer validation machine learning models may be used to output a transfer validation prediction. The present disclosure contemplates that any machine learning, artificial intelligence, or the like technique may be used as a wire transfer validation machine learning model based upon the intended application of the disclosed system(s).

The term “transfer validation prediction object” refers to a data object that provides the dataset generated by the wire transfer validation machine learning model for a corresponding transfer request. In some embodiments, the transfer validation prediction object may be stored on the storage subsystem of the wire transfer validation server or any other computing device of the present disclosure.

The term “wire transfer validation interface” refers to a graphical user interface configured to provide, display, or otherwise contain a transfer validation prediction based on the data objects and machine learning model(s) of the present disclosure (e.g., one or more wire transfer validation machine learning models).

The term “score identifier” refers to data, text, identifiers, metadata, or other alert related characteristics or features that are extracted from a set of wire transfers and used to create a training set of wire transfers as described hereafter. Score identifiers may be extracted from a set of wire transfers by a wire transfer validation server using one or more of a machine learning models, such as a wire transfer validation machine learning model, a natural language processor (NLP), and/or a text mining operation. For example, a score identifier may comprise text string(s), numerical character(s), alphabetical character(s), alphanumeric code(s), ASCII character(s), a pointer, an IP address, a MAC address, a memory address, other unique identifier, or a combination thereof.

The term “updated score identifier” refers to one or more items of data by which a wire transfer validation prediction may be identified by a wire transfer validation server of the present disclosure. For example, an updated score identifier may comprise text string(s), numerical character(s), alphabetical character(s), alphanumeric code(s), ASCII character(s), a pointer, an IP address, a MAC address, a memory address, other unique identifier, or a combination thereof.

The term “recipient identifier” refers to one or more items of data by which a wire transfer validation prediction may be identified by a wire transfer validation server. For example, a recipient identifier may comprise text string(s), numerical character(s), alphabetical character(s), alphanumeric code(s), ASCII character(s), a pointer, an IP address, a MAC address, a memory address, other unique identifier, or a combination thereof. As described hereafter, a recipient identifier may include data entries indicative of or associated with a particular user, user device, or the like that may receive funds associated with or defined by a transfer request.

The term “location identifier” refers to one or more items of data by which a wire transfer validation prediction may be identified by a transfer validation server system. For example, a location identifier may comprise text string(s), numerical character(s), alphabetical character(s), alphanumeric code(s), ASCII character(s), a pointer, an IP address, a MAC address, a memory address, other unique identifier, or a combination thereof. As described hereafter, a location identifier may include data entries indicative of or associated with a particular physical of a user, user device or the like that may be associated with a transfer request.

The term “account identifier” refers to one or more items of data by which a wire transfer validation prediction may be identified by a wire transfer validation server. For example, an account identifier may comprise text string(s), numerical character(s), alphabetical character(s), alphanumeric code(s), ASCII character(s), a pointer, an IP address, a MAC address, a memory address, other unique identifier, or a combination thereof. As described hereafter, an account identifier may include data entries indicative of or associated with a particular user account, client account, entity account, or the like that may provide or receive funds associated with or defined by a transfer request.

The term “wire transfer report” refers to a collection of wire transfers and wire transfer related data that is received from one or more report databases over a specified time period. Wire transfer reports may further comprise identifying data of one or more recipients of one or more wire transfers, wherein the wire transfer report, or set of wire transfer reports, may comprise data objects indicating one or more wire transfer scams (e.g., articles discussing or disclosing wire transfer scams and identifying data of the fraudulent entity of the wire transfer scam and/or an entity or device associated with the wire transfer). The wire transfer related dataset may be stored in the storage subsystem of the wire transfer validation server or the like.

Having set forth a series of definitions called-upon throughout this application, an example system architecture and example apparatus is described below for implementing example embodiments and features of the present disclosure.

### Example System Architecture

Systems, computer program products, and methods of the present disclosure may be embodied by any of a variety of devices. For example, the systems and methods of an example embodiment may be embodied by a networked computing device (e.g., an enterprise platform), such as a server or other network entity, configured to communicate with one or more devices, such as one or more client devices, one or more user devices, and one or more external servers. Additionally, or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable computer, or any combination of the aforementioned devices.

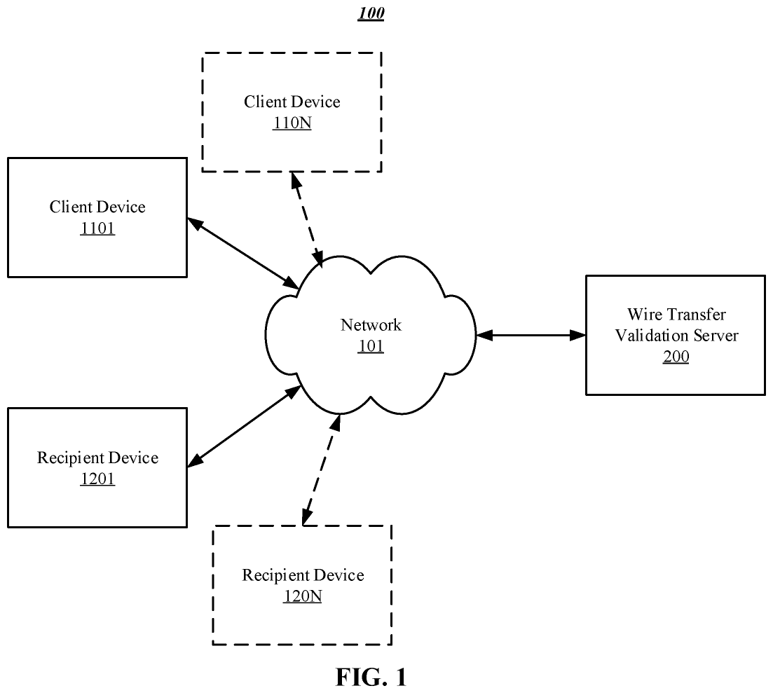

With reference to FIG. 1, an example system 100 is illustrated with an apparatus (e.g., wire transfer validation server 200) (e.g., server 200) communicatively connected via a network 101 to one or more client devices 1101 to 110N and communicatively connected via a network 101 to one or more recipient devices 1201 to 120N. The wire transfer validation server 200 may comprise one or more wire transfer validation server databases.

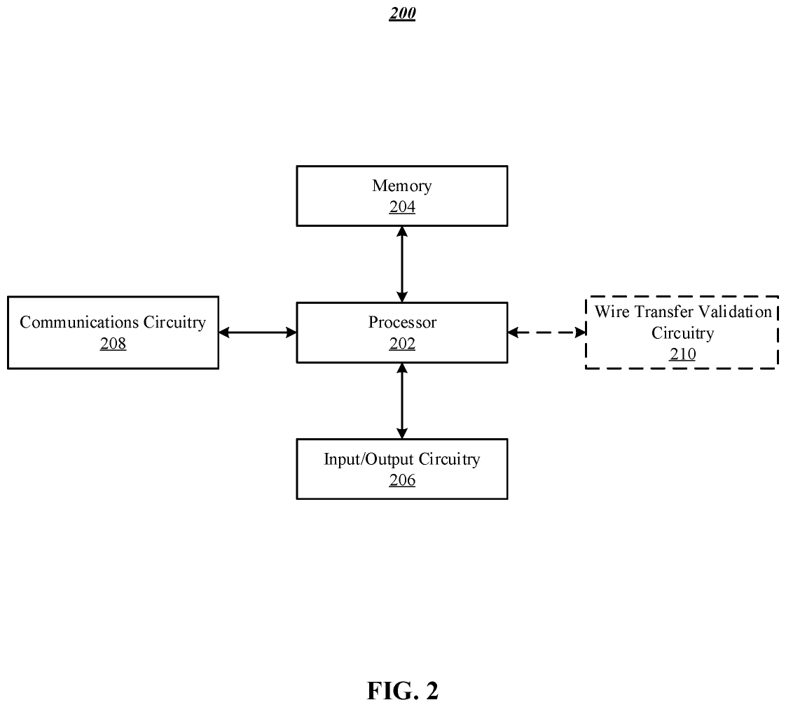

The wire transfer validation server 200 may include circuitry, networked processors, or the like configured to perform some or all of the apparatus-based (e.g., wire transfer validation server-based) processes described herein, and may be any suitable network server and/or other type of processing device. In this regard, the wire transfer validation server 200 may be embodied by any of a variety of devices. For example, the wire transfer validation server 200 may be configured to receive/transmit data and may include any of a variety of fixed terminals, such as a server, desktop, or kiosk, or it may include any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various factors and designs but will nevertheless include at least the components likened in FIG. 2 and described in connection therewith.

In some embodiments, the wire transfer validation server 200 may be located remotely from the one or more client devices 1101 to 110N (e.g., the first client device 1101, a second client device 1102 (not pictured), and the N^{th} client device 110N), and/or recipient devices 1201 to 120N (e.g., the first recipient device 1201, a second recipient device 1202 (not pictured), and the N^{th} recipient device 120N). In other embodiments, the wire transfer validation server 200 may comprise one or more separate or distinct computing devices, the one or more client devices (e.g., the first client device 1101, the second client device 1102 (not pictured), and the N^{th} client device 110N), and/or recipient devices 1201 to 120N (e.g., the first recipient device 1201, a second recipient device 1202 (not pictured), and the N^{th} recipient device 120N). Said differently, the present disclosure contemplates that each of the devices illustrated in FIG. 1 may perform operations that occur remotely from or locally to the wire transfer validation server 200. The wire transfer validation server 200 may, in some embodiments, comprise several servers or computing devices performing interconnected and/or distributed functions. Despite the many arrangements contemplated herein, the wire transfer validation server 200 is shown and described herein as a single computing device to avoid unnecessarily overcomplicating the disclosure.

The network 101 may include one or more wired and/or wireless communication networks including, for example, a wired or wireless local area network (LAN), personal area network (PAN), metropolitan area network (MAN), wide area network (WAN), or the like, as well as any hardware, software and/or firmware for implementing the one or more networks (e.g., network routers, switches, hubs, etc.). For example, the network 101 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the network 101 may include a public network, such as the Internet, a private network, such as an intranet, or combinations thereof, and may utilize a variety of networking protocols now available or later developed including, but not limited to TCP/IP based networking protocols.

The client device(s) 1101 to 110N may refer to a client device associated with a client (e.g., sender of the wire transfer and/or generator of the transfer request) as defined above and may be a cellular telephone (e.g., a smartphone and/or other type of mobile telephone), laptop, tablet, electronic reader, e-book device, media device, wearable, smart glasses, smartwatch, or any combination of the above. Similarly, the recipient device(s) 1201 to 120N may refer to a device associated with a recipient as defined above and may also be a cellular telephone (e.g., a smartphone and/or other type of mobile telephone), laptop, tablet, electronic reader, e-book device, media device, wearable, smart glasses, smartwatch, or any combination of the above. Although described hereafter with reference to a client device 1101 to 110N and a recipient device 1201 to 120N, the example system 100 may include N number of client devices 1101 associated with the same user or any number of respective other users or clients. By way of example, the client device 1101 may be associated with a client that requests the wire transfer (e.g., submits a transfer request to the recipient associated with the recipient device 1201), and such a wire transfer request (e.g., transfer request) may first be received by the wire transfer validation server 200 for validation of recipient identified by the transfer request. Although illustrated in FIG. 1 as distinct elements, the present disclosure contemplates that the wire transfer validation server 200 may be, in whole or in part, stored by the client devices 1101 and/or 110N. In some embodiments, the present disclosure contemplates the wire transfer validation server 200 may be, in whole or in part, stored by the recipient device 1201.

### Exemplary Wire Transfer Validation Server

The wire transfer validation server 200 may be embodied by one or more computing devices or systems, such as shown in FIG. 2 (e.g., an apparatus of the present disclosure). The wire transfer validation server 200 may include processor 202, memory 204, input/output circuitry 206, and communications circuitry 208. In some embodiments, the wire transfer validation server 200 may include wire transfer validation circuitry 210. The server 200 may be configured to execute the operations described herein. Although these components 202-210 are described with respect to functional limitations, it should be understood that the particular implementations necessarily include the use of particular hardware. It should also be understood that certain of these components 202-210 may include similar or common hardware. For example, two sets of circuitries may both leverage use of the same processor, network interface, storage medium, or the like to perform their associated functions, such that duplicate hardware is not required for each set of circuitries.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the wire transfer validation server 200 may provide or supplement the functionality of particular circuitry.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present disclosure.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

In some embodiments, the wire transfer validation server 200 may include input/output circuitry 206 that may, in turn, be in communication with processor 202 to provide output to the user and, in some embodiments, to receive an indication of a user input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the wire transfer validation server 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna/antennae to cause transmission of signals via the antenna/antennae or to handle receipt of signals received via the antenna/antennae. These signals may be transmitted by the wire transfer validation server 200 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols.

The wire transfer validation circuitry 210 may comprise hardware components configured to validate a wire transfer based upon one or more identifiers of a potential recipient (e.g., a recipient identifier, an account identifier, a score identifier, and a location identifier). The wire transfer validation circuitry 210 may comprise one or more wire transfer validation machine learning models, described in further detail herein, one or more natural language processors (NLP), and/or one or more databases comprising one or more training sets of wire transfers (e.g., a first training set of wire transfers, a second training set of wire transfers, a third training set of wire transfers, an N^{th} training set of wire transfers). The wire transfer validation circuitry 210 may utilize processing circuitry, such as the processor 202, to perform its corresponding operations, and may utilize memory 204 to store collected information.

It should also be appreciated that, in some embodiments, the wire transfer validation circuitry 210, may include a separate processor, specially configured field programmable gate array (FPGA), or application specific interface circuit (ASIC) to perform its corresponding functions. In addition, computer program instructions and/or other type of code may be loaded onto a computer, processor or other programmable wire transfer validation server's circuitry to produce a machine, such that the computer, processor other programmable circuitry that execute the code on the machine create the means for implementing the various functions, including those described in connection with the components of wire transfer validation server 200.

As described above and as will be appreciated based on this disclosure, embodiments of the present disclosure may be configured as systems, methods, mobile devices, and the like. Accordingly, embodiments may comprise various means including entirely of hardware or any combination of software with hardware. Furthermore, embodiments may take the form of a computer program product comprising instructions stored on at least one non-transitory computer-readable storage medium (e.g., computer software stored on a hardware device). Any suitable computer-readable storage medium may be utilized including non-transitory hard disks, CD-ROMs, flash memory, optical storage devices, or magnetic storage devices.

### Exemplary Client Device

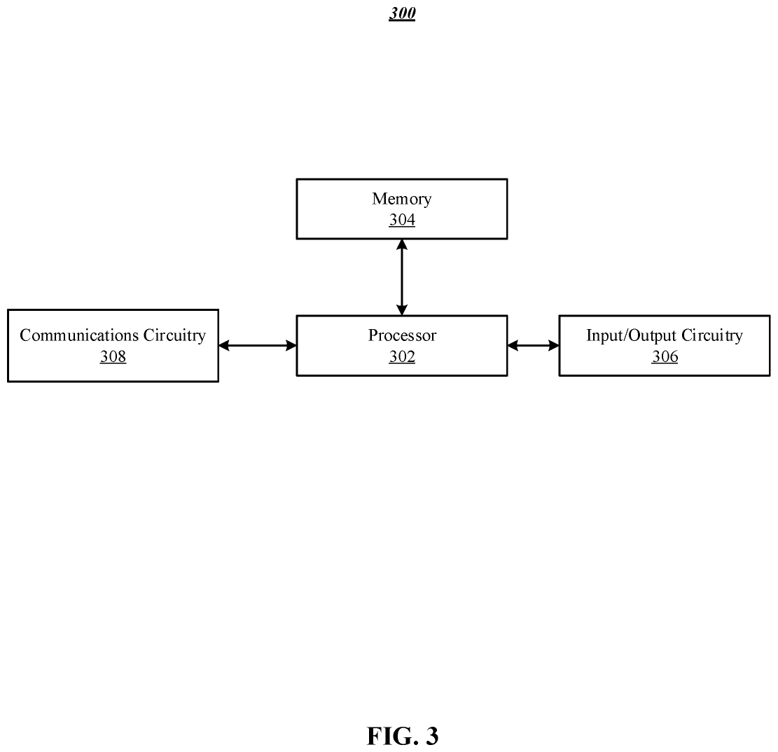

Referring now to FIG. 3, a client device may be embodied by one or more computing systems, such as apparatus 300 shown in FIG. 3. The apparatus 300 may include processor 302, memory 304, input/output circuitry 306, and a communications circuitry 308. Although these components 302-308 are described with respect to functional limitations, it should be understood that the particular implementations necessarily include the use of particular hardware. It should also be understood that certain of these components 302-308 may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may include one or more databases. Furthermore, the memory 304 may be configured to store information, data, content, applications, instructions, or the like for enabling the apparatus 300 to carry out various functions in accordance with example embodiments of the present disclosure.

The processor 302 may be embodied in a number of different ways and may, for example, include one or more processing devices configured to perform independently. In some preferred and non-limiting embodiments, the processor 302 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 302 may be configured to execute instructions stored in the memory 304 or otherwise accessible to the processor 302. In some preferred and non-limiting embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment of the present disclosure while configured accordingly. Alternatively, as another example, when the processor 302 is embodied as an executor of software instructions (e.g., computer program instructions), the instructions may specifically configure the processor 302 to perform the algorithms and/or operations described herein when the instructions are executed.

In some embodiments, the apparatus 300 may include input/output circuitry 306 that may, in turn, be in communication with processor 302 to provide output to the user and, in some embodiments, to receive an indication of a user input. The input/output circuitry 306 may comprise a user interface and may include a display, and may comprise a web user interface, a mobile application, a query-initiating computing device, a kiosk, or the like.

In embodiments in which the apparatus 300 is embodied by a limited interaction device, the input/output circuitry 306 includes a touch screen and does not include, or at least does not operatively engage (i.e., when configured in a tablet mode), other input accessories such as tactile keyboards, track pads, mice, etc. In other embodiments in which the apparatus is embodied by a non-limited interaction device, the input/output circuitry 306 may include may include at least one of a tactile keyboard (e.g., also referred to herein as keypad), a mouse, a joystick, a touch screen, touch areas, soft keys, and other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 304, and/or the like).

The communications circuitry 308 may be any means such as a device or circuitry embodied in either hardware or a combination of hardware and software that is configured to receive and/or transmit data from/to a network and/or any other device, circuitry, or module in communication with the apparatus 300. In this regard, the communications circuitry 308 may include, for example, a network interface for enabling communications with a wired or wireless communication network. For example, the communications circuitry 308 may include one or more network interface cards, antennae, buses, switches, routers, modems, and supporting hardware and/or software, or any other device suitable for enabling communications via a network. Additionally, or alternatively, the communications circuitry 308 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 300. In some embodiments, one or more external systems (such as a remote cloud computing and/or data storage system) may also be leveraged to provide at least some of the functionality discussed herein. As described above, in some embodiments, functionality, circuitry, etc. of the wire transfer validation server 200 may, in whole or in part, be contained or performed by an example client device, user device, recipient device, etc. of the present disclosure.

### Example Data Flows and Operations

### Example Model Training Operations

Provided herein are techniques for training at least a wire transfer validation prediction machine learning model. In some embodiments, similar techniques may be used to train a plurality of wire transfer validation machine learning models which may be used in together within a complex neural network (CNN) and/or a deep neural network (DNN) to generate a transfer validation prediction object.

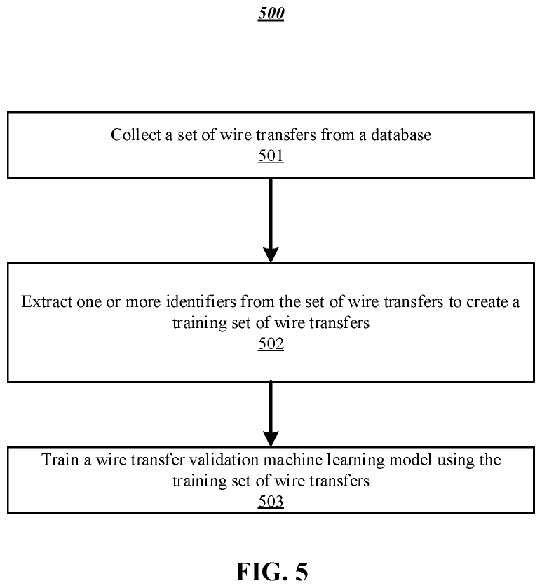

FIG. 5 is a flowchart diagram of an example process 500 for performing operations that are configured to train a wire transfer validation prediction machine learning model. The operations illustrated in FIG. 5 may, for example, be performed by, with the assistance of, and/or under the control of an apparatus (e.g., wire transfer validation server 200), as described above. In this regard, performance of the operations may invoke one or more of processor 202, memory 204, input/output circuitry 206, communications circuitry 208, and/or wire transfer validation circuitry 210. Via the various operations of process 500, the wire transfer validation server 200 may train one or more wire transfer validation prediction machine learning models to generate one or more transfer validation prediction objects based on one or more transfer requests (e.g., real-time transfer requests or the like) in an efficient manner without human interaction which may, in turn, be used to generate a wire transfer validation interface for transmission to a client device 1101.

As shown in operation 500, the apparatus (e.g., wire transfer validation server 200) includes means, such as input/output circuitry 206, communications circuitry 208, or the like, for extracting and collecting a set of wire transfers from a database. Such a database of wire transfers may be populated with data associated with one or more wire transfer scams extracted from one or more online and/or non-online resources. Such online and/or non-online resources may comprise articles discussing wire transfer scams, financial institution databases tracking user and/or client instances of wire transfer scams, social media accounts discussing wire transfer scams (e.g., including first-hand recitations of wire transfer scams by a defrauded social media account user), and/o other such online and/or non-online resources comprising data related to one or more wire transfer scams. In some embodiments, the online and/or non-online resources may be text mined to extract specific paragraphs, sentences, phrases, words, and other such written data objects comprising information regarding wire transfer scams. For example, the wire transfer validation server 200 may mine one or more online and/or non-online resources to identify paragraphs, sentences, phrases, and/or the like comprising words associated with or linked to “scam,” “fraud,” “racket,” “fake,” “lottery,” “counterfeit,” “deception,” “deceive,” “fake,” “imposter,” “money,” and/or “wire transfer.” In some embodiments, the text mining may employ a natural language processor (NLP) to parse one or more paragraphs, sentences, phrases, and/or words to link to an associated word of any of the listed words described herein.

For example, an NLP may identify a word such as “sham” as linked to the word “scam” which may be used to extract the sentence, paragraph, and/or entire entry of text data surrounding the word “sham,” in order for the NLP to further parse and extract phrases surrounding the word “sham” to be input into a wire transfer database. In some embodiments, further text and/or phrases may be text mined if one or more of the words described herein (e.g., “scam,” “fraud,” “racket,” “fake,” “lottery,” “counterfeit,” “deception,” “deceive,” “fake,” “imposter,” “money,” and/or “wire transfer”) have already been identified in an online and/or non-online resource, such further text and/or phrases that may be linked to specific types of wire transfer scams such as “gift cards,” “email,” “phone call(s),” “lottery,” “lotteries,” “craigslist,” “classified advertisements,” “classified ads,” “real estate,” and other such instances of specific forms of wire transfer scams. Such a database of specific language to be extracted and parsed may be updated at predetermined times based upon each instance a text mining operation is performed on one or more online and/or non-online resources.

In some embodiments, the NLP may extract and parse one or more non-text resources, such as videos and/or images comprising information on one or more wire transfer scams. Such videos and/or images may comprise news reels (e.g., a collection of related images) extracted from a database associated with a news provider, videos and/or images generated by one or more users/clients associated personal or non-personal experiences of wire transfer scams (e.g., such as uploaded or streamed videos by a user/client) and/or other non-text data objects capable of parsing by an NLP.

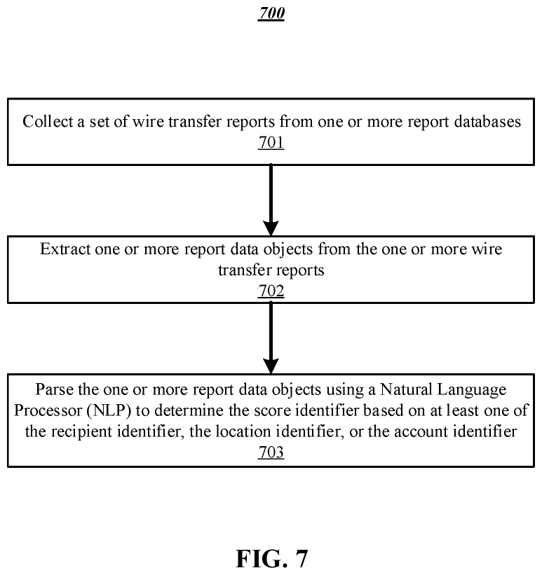

In some embodiments, the use of online and/or non-online resources may comprise the use of one or more wire transfer reports such as a wire transfer report housed in a financial institution's database comprising information on one or more wire transfer scams reported by a user and/or client of the financial institution. Such an embodiment may be shown in an exemplary flowchart of process 700 of FIG. 7.

Turning now to FIG. 7, a flowchart diagram of an example process 700 for performing operations that are configured to train a wire transfer validation prediction machine learning model using a set of wire transfer reports from one or more report databases is illustrated. The operations illustrated in FIG. 7 may, for example, be performed by, with the assistance of, and/or under the control of an apparatus (e.g., wire transfer validation server 200), as described above. In this regard, performance of the operations may invoke one or more of processor 202, memory 204, input/output circuitry 206, communications circuitry 208, and/or wire transfer validation circuitry 210. Via the various operations of process 700, the wire transfer validation server 200 may train one or more wire transfer validation prediction machine learning models to generate one or more transfer validation prediction objects based on one or more transfer requests (e.g., real-time transfer requests or the like) and a set of wire transfer reports extracted and collected from one or more report databases, in an efficient manner without human interaction which may, in turn, be used to generate a wire transfer validation interface for transmission to a client device 1101.

As shown at operation 701 of process 700, the apparatus (e.g., wire transfer validation server 200) includes means, such as input/output circuitry 206, communications circuitry 208, or the like, for collecting a set of wire transfer reports from one or more report databases, such as a report database housed and updated by a financial institution. In some embodiments, one or more financial institutions may track wire transfer scams that have happened to the financial institution's users and/or clients (e.g., members or clients of the financial institution), wherein users and/or clients of the financial institution may submit a report of a potential wire transfer scam including one or more details of the wire transfer scam and/or the recipient. For example, a user and/or client may submit a report to their financial institution comprising details of the recipient of the wire transfer including one or more identifiers (e.g., recipient identifier, location identifier, account identifier, entity identifier, and/or time identifier).

In some embodiments, multiple financial institutions may house and update individual databases of wire transfer scams comprising a plurality of wire transfer reports. In some embodiments, and as shown at operation 701, the wire transfer validation server 200 may collect a set of wire transfer reports from a single report database (e.g., operated and stored by a financial institution), from a plurality of report databases (e.g., operated and stored by a plurality of financial institutions, each operating and storing data generated within respective systems and by their users and/or clients), and/or from a single of database operated and stored on a remote server from the plurality of financial institutions and accessible via a network (e.g., network 101) by a plurality of financial institutions. In some embodiments, each of the databases of wire transfer reports may be accessible by the wire transfer validation server 200 to collect a set of wire transfer reports at operation 701.

In some embodiments, and as shown at operation 702, the apparatus (e.g., wire transfer validation server 200) includes means, such as input/output circuitry 206, communications circuitry 208, processor 202 or the like, for extracting one or more report data objects from one or more wire transfer reports. Such report data objects may comprise data generated by a user and/or client of an example financial institution in reporting a wire transfer scam. For example, the report data objects may comprise the name of the user and/or client of the financial institution, the account details of the user and/or client, the time at which the wire transfer scam occurred, and/or the time at which the recipient contacted the user and/or client for the item being transmitted (e.g., a monetary amount via wire transfer and/or other sensitive information) associated with the transfer request, the time at which the wire transfer occurred, the recipient account details (e.g., account identifier), details about the recipient (e.g., recipient identifier), a location of the recipient (e.g., location identifier), a location of the wire transfer transmission (e.g., location identifier or where wire transfer was transmitted), and/or entity details of the recipient (e.g., entity identifier). For example, one or more reports generated by a user and/or client of an example financial institution may include one or more fraudulent wire transfer complaints including at least one of the report data objects described in detail hereinabove associated with a recipient of a completed wire transfer scam. In some embodiments, the parsed score identifier, recipient identifier, account identifier, location identifier, entity identifier, and/or time identifier from the one or more reports may be processed by the wire transfer validation machine learning model to train the wire transfer validation machine learning model. Further, in some embodiments, for the recipient identifier, account identifier, location identifier, entity identifier, and/or time identifier previously identified with respect to a specific recipient (e.g., identified with a recipient who has been involved in a wire transfer scam), the training of the wire transfer machine learning model may include updating or generating a new score identifier based upon a previous score identifier associated with the recipient and based upon a newly processed report generated by a user and/or client. For example, the wire transfer validation machine learning model may be continuously trained based upon newly received reports from one or more users and/or clients of the financial institution(s) or the like.

As shown at operation 703, the apparatus (e.g., wire transfer validation server 200) includes means, such as processor 202, wire transfer validation circuitry 210, or the like, for using the NLP and/or text mining operations to determine the score identifier based on at least one of the recipient identifier, the location identifier, or the account identifier. In some embodiments, the identifiers used to train the wire transfer validation machine learning model may further comprise an entity identifier and/or a time identifier. In some embodiments, the report data objects may comprise additional data not associated with any of the outlined identifiers herein described. For example, in an instance in which the report data objects comprise data outside of the identifiers herein described, a text mining operation and NLP may be used to extract and parse the identifiers from the non-identifier data objects of the report data objects. In such an embodiment, the database of training sets (e.g., the report data objects and the associated identifiers) are all that may be stored in a database comprising the training materials of the wire transfer validation machine learning model. In this approach, storage subsystems for such training of the wire transfer validation machine learning model may comprise less data overall (e.g., reduce the memory burdens of the system) and may allow quicker processing of the specific identifiers used to train the wire transfer validation machine learning models.

Turning back to operation 501 of FIG. 5, once data has been extracted and parsed by a text mining operation and/or an NLP, the data associated with one or more wire transfers (e.g., wire transfers reported through online and/or non-online resources) may be collected into at least one database associated with the wire transfer validation server (e.g., wire transfer validation server 200 and/or wire transfer validation circuitry 210) to generate a set of wire transfers.

In some embodiments, and as shown at operation 502, the apparatus (e.g., wire transfer validation server 200) includes means, such as processor 202, wire transfer validation circuitry 210, or the like, for extracting one or more identifiers from the set of wire transfers to create a training set of wire transfers, wherein the training set of wire transfers comprises a score identifier and at least one of a recipient identifier, a location identifier, and/or an account identifier. In some embodiments, the one or more identifiers may further comprise a time identifier, an entity identifier, and other such identifiers to be associated with one or more potential recipients for identification of one or more potential recipients within the wire transfer validation server. The present disclosure contemplates that this data may be associated with any identifier based upon the intended application of the wire transfer validation server 200.

In some embodiments, the score identifier may be associated with a transfer validation prediction object and may be updated within the wire transfer validation server storage subsystem (e.g., comprised within the wire transfer validation server 200 or the like) whenever another identifier (e.g., recipient identifier, location identifier, account identifier, time identifier, and/or entity identifier) are used to generate a meta score associated with the transfer validation prediction object. The meta score of the transfer validation prediction object, which may be associated with a transfer request such that the transfer validation prediction object is generated in real-time or substantially real-time for the transfer request, may be used to update the score identifier associated with one or more of the identifiers used herein to generate said meta score. For example, if the recipient identifier based on the one or more online and/or non-online resources comprises identifying information of a potential recipient and specifically identifies recipient A (e.g., by the recipient's name) within one or more online and/or non-online resources as being a part of a wire transfer scam, a score identifier may be generated indicating a high likelihood of the recipient identifier (e.g., recipient A) being associated with one or more future wire transfer scams.

In some embodiments, once the same recipient identifier is identified by a real-time transfer request as a potential recipient, a score identifier may be generated based upon the previously generated score identifier within the wire transfer validation server storage subsystem. In some embodiments, a meta score may be generated by a wire transfer validation machine learning model after being trained by a training set of wire transfers (e.g., a first training set of wire transfers, a second set of wire transfers, a third set of wire transfers, etc.), the meta score may be assigned to the stored score identifier so that the score identifier associated with one or more other identifiers (e.g., an account identifier, a recipient identifier, a location identifier, an entity identifier and/or a time identifier) may be updated based upon the newly generated meta score. In some embodiments, the set of wire transfers used to create the training set of wire transfers (e.g., a first training set of wire transfers) may be generated over a specified time period (e.g., a first time period) such that one or more training sets of wire transfers may be used without significant overlap of training data, or any overlap of training data.

The account identifier associated with the one or more identifiers of the training set of wire transfers may classify specific account data objects (e.g., account numbers and/or tokens of a bank account associated with the potential recipient for said wire transfer, a routing number and/or token of a bank account associated with the potential recipient for said wire transfer, and other such identifying data objects associated with an account of the potential recipient). In some embodiments, the account identifier may comprise non-banking information for transmission of the wire transfer, such as an email address associated with the potential recipient, a mailing address associated with the potential recipient, and/or a phone number associated with the potential recipient. In some embodiments, scannable indica (e.g., a QR Code, a data matrix, a barcode, and/or a code) may be processed to identify an account identifier associated with the potential recipient for said wire transfer. For example, scannable indicia may, in response to scanning, image capture, or the like of the scannable indicia provide data objects identifying one or more account identifiers used to train the wire transfer validation machine learning model. The scannable indicia may be scanned by a computing device via imaging methods, image processing, or the like and processed by the wire transfer validation machine learning model to identify one or more specific account data objects associated with the account identifiers. For example, the scannable indicia may include identifying data of the associated account for a recipient (e.g., for training of the wire transfer validation machine learning model), such as the account number and/or tokens of a bank account associated with the recipient, routing number and/or tokens of a bank account associated with the recipient, and/or other such identifying data objects associated with an account of the recipient such as non-banking information (e.g., name of recipient, email address associated with the recipient, mailing address associated with the recipient, and/or a phone number associated with the recipient). The wire transfer validation machine learning model may use a computing device comprising imaging methods, image processing, or the like to identify and parse scannable indicia in order to extract such information and/or data objects described herein to train the wire transfer validation machine learning model. In some embodiments, the wire transfer validation server may not be limited to a monetary wire transfer validation but may comprise data identifying a potential recipient of sensitive information such as documents comprising sensitive information or other such non-monetary items for wire transfer. In some such embodiments, the account identifier may comprise other identifying information for routing the sensitive information to the potential recipient, such as an email address, a mailing address, and/or a phone number.

The recipient identifier associated with the one or more identifiers of the training set of wire transfers may classify specific identifying data objects associated with the potential recipient (e.g., the full legal name of the recipient, a well-known nickname of the recipient, a phone number associated with the recipient, an email address associated with the recipient, and/or an address associated with the recipient). In some embodiments, scannable indicia (e.g., QR Code, data matrix, barcode, and/or code) may be processed to identify a recipient identifier for a wire transfer. For example, the scannable indica may be used to train the wire transfer validation machine learning model by identifying (e.g., parsing, extracting, and/or collecting) recipient identifiers based on the scannable indicia which may be scanned by a computing device via imaging methods, image processing, or the like and processed by the wire transfer validation machine learning model to identify one or more specific identifying data objects associated with the recipient from the scannable indicia. For example, the scannable indicia may comprise identifying data of a specific recipient (e.g., for training of the wire transfer validation machine learning model), such as a recipient's full legal name, a well-known nickname associated with the recipient, a phone number associated with the recipient, an email address associated with the recipient, and/or an address associated with the recipient.

The location identifier associated with the one or more identifiers of the training set of wire transfers may classify specific location data objects associated with the potential recipient (e.g., an address associated with the recipient, a region where the recipient may live or work, a town associated with the recipient (e.g., a town of residence or work), a country associated with the recipient (e.g., a country of residence or work), an address associated with the account identifier of the recipient (e.g., an address associated with the recipient's bank account)). In some embodiments, scannable indicia (e.g., QR Code, data matrix, barcode, and/or code) may be processed to identify a location identifier for said wire transfer. For example, the scannable indica may be used to train the wire transfer validation machine learning model by identifying (e.g., parsing, extracting, and/or collecting) location identifiers of the scannable indicia. For example, the scannable indicia may include location data of a specific recipient (e.g., for training of the wire transfer validation machine learning model), such as the recipient's address (e.g., an address associated with the recipient, a region where the recipient may live or work, a town associated with the recipient (e.g., a town of residence or work), a country associated with the recipient (e.g., a country of residence or work), an address associated with the account identifier of the recipient (e.g., an address associated with the recipient's bank account)). For example, the scannable indicia may include or otherwise be indicative of location data of a specific recipient (e.g., for training of the wire transfer validation machine learning model), such as the recipient's address information.

The entity identifier associated with the one or more identifiers of the training set of wire transfers may classify specific entities associated with the potential recipient (e.g., a company associated with the recipient for which the recipient is known to work). In some embodiments, scannable indicia (e.g., QR Code, data matrix, barcode, and/or code) may be processed to identify an entity identifier for said wire transfer. For example, the scannable indica may be used to train the wire transfer validation machine learning model by identifying (e.g., parsing, extracting, and/or collecting) entity identifiers of the scannable indicia associated with the recipient. For example, the scannable indicia may include entity data of a specific recipient (e.g., for training of the wire transfer validation machine learning model), such as the recipient's associated companies and/or entities (e.g., a company associated with the recipient for which the recipient is known to work). For example, the scannable indicia may comprise entity data of a specific recipient (e.g., for training of the wire transfer validation machine learning model), such as the recipient's known entities and/or companies for which the recipient has been known to have an association.

The time identifier associated with the one or more identifiers of the training set of wire transfers may classify specific time data object associated with the transfer request (e.g., a time of day associated with the transfer request, where a specific time of day may be more likely to be associated with an increased likelihood of a potential wire transfer scam). In some embodiments, scannable indicia (e.g., QR Code, data matrix, barcode, and/or code) may be processed to identify a time identifier for said wire transfer. For example, the scannable indica may be used to train the wire transfer validation machine learning model by identifying (e.g., parsing, extracting, and/or collecting) time identifiers of the scannable indicia associated with the transfer request. For example, the scannable indicia may include time data of a specific transfer request (e.g., for training of the wire transfer validation machine learning model), such as the time for which the transfer request was created and/or transmitted, the time for which the original request by the potential recipient was created and/or transmitted to the client, and/or the time for which the transfer request was approved and a wire transfer was completed. For example, the scannable indicia may include time data of a specific transfer request (e.g., for training of the wire transfer validation machine learning model), such as the time of day, the day of the month, the day of the year, and other such time periods for which a transfer request occurred and/or was completed.

In some embodiments, and as shown at operation 503, the apparatus (e.g., wire transfer validation server 200) includes means, such as processor 202, wire transfer validation circuitry 210, or the like, for training a wire transfer validation machine learning model using a training set of wire transfers. The one or more identifiers, comprising the score identifier and at least one of a recipient identifier, an account identifier, a location identifier, an entity identifier, and/or a time identifier, may be used within the training set of wire transfers to train the wire transfer validation machine learning model to predict a transfer validation prediction based upon the generated meta score after training the wire transfer validation machine learning model using one or more training set(s) of wire transfers.

In some embodiments, the wire transfer validation machine learning model may process every identifier of the transfer request to generate the meta score by aggregating a score identifier of each other identifier (e.g., a recipient identifier, an account identifier, a location identifier, an entity identifier, and/or a time identifier) to generate the meta score.

In some embodiments, a specific weight may be assigned to each identifier in order to generate the meta score. For example, an account identifier associated with a previously identified recipient of a wire transfer scam may be weighed more heavily for the meta score (e.g., the score identifier associated with the account identifier may be weighted more heavily such that the score identifier is multiplied by the associated weight to return a score identifier to be aggregated with the score identifiers for the identifiers (a recipient identifier, a location identifier, an entity identifier, and/or a time identifier) to generate a higher meta score). In some embodiments, a phone number of the potential recipient, which may be associated with the recipient identifier, may be weighted more heavily than the other identifiers (e.g., an account identifier, a location identifier, an entity identifier, and/or a time identifier) to generate a higher meta score.

In some embodiments, once the meta score associated with the transfer request has been generated, the meta score may be assigned and/or applied to the score identifier of the extracted set of wire transfers to create an updated score identifier associated with at least one of the recipient identifier, the location identifier, the account identifier, the entity identifier, and/or the time identifier. In some embodiments, the updated score identifier for each of the other identifiers (e.g., the recipient identifier, the location identifier, the account identifier, the entity identifier, and/or the time identifier) may be stored with the wire transfer validation machine learning model to update the database for training of the wire transfer validation machine learning model. For example, once the transfer request has been processed by the wire transfer validation machine learning model, including its identifying data (e.g., personally-identifying data of the potential recipient), the score identifier associated with each of the identifiers (e.g., the recipient identifier, the location identifier, the account identifier, the entity identifier, and/or the time identifier) may be updated for a more robust database of training sets of wire transfers.

In some embodiments, a plurality of wire transfer validation machine learning models may be clustered together to be processed sequentially or concurrently with each other wire transfer validation machine learning model to process specific identifiers (e.g., a wire transfer validation machine learning model to process only one specific identifier).

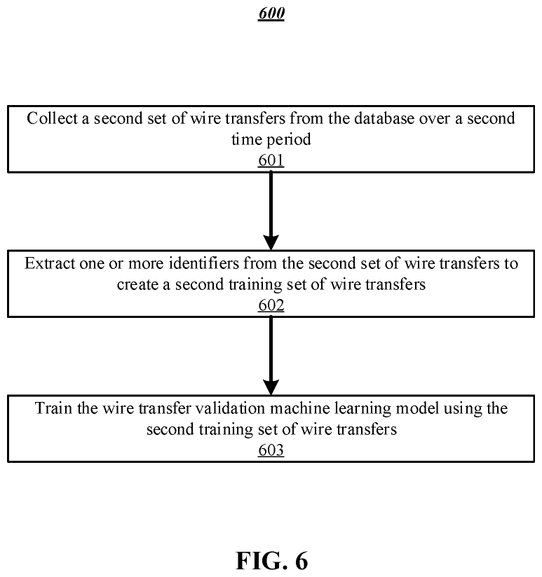

In some embodiments, and as shown in FIG. 6 at method 600, the wire transfer validation machine learning model may be trained using a second set of wire transfers. In some embodiments, the operations illustrated in FIG. 6 may, for example, be performed by, with the assistance of, and/or under the control of an apparatus (e.g., wire transfer validation server 200), as described above. In this regard, performance of the operations may invoke one or more of processor 202, memory 204, input/output circuitry 206, communications circuitry 208, and/or wire transfer validation circuitry 210. As shown in operation 601, the apparatus (e.g., wire transfer validation server 200) includes means, such as processor 202, wire transfer validation circuitry 210, or the like, for collecting a second set of wire transfers from a database over a second time period. In a similar manner to the process described in process 500, the second set of wire transfers may be collected from one or more online and/or non-online resources, wherein the use of a text mining operation and NLP to extract and parse specific language or linked language may be used to form the second set of wire transfers within the database. In some embodiments, the second set of wire transfers may be collected based on a specified second time period. In some embodiments, the second time period may comprise a time period not including any portion of time comprised within the set of wire transfers extracted in method 500 (e.g., the first time period). For example, if the data of the set of wire transfers of method 500 is extracted and parsed over a first time period, and the second set of wire transfers may be extracted and parsed over a different time period, the second time period, there may be no overlap of time occurs between the first time period and the second time period. In some embodiments, a data object for each wire transfer data within the set of wire transfers may comprise a time specific indicator of the date and time the wire transfer data was generated in the online and/or offline resource, such that only those online and/or offline resources within a specified time period are included (e.g., first time period). The data object associated with the wire transfer data of the generated date and time may be within the specified time period. For example, for those online and/or offline resource comprising data objects indicating a date and time of generation for the resource as a data and time comprised in a second time period, then the data of the wire transfer may be sorted into the second set of wire transfers over the second time period.

In some embodiments, and as shown at operation 602, the apparatus (e.g., wire transfer validation server 200) includes means, such as processor 202, wire transfer validation circuitry 210, or the like, for extracting one or more identifiers from the second set of wire transfers to create a second training set of wire transfers. In some embodiments, and as already described in detail above, a text mining operation and/or NLP may be used to identify and extract the identifiers from each wire transfer of the second set of wire transfers. In some embodiments, and as shown at operation 603, the wire transfer validation machine learning model may be further trained using the second training set of wire transfers.

### Example Wire Transfer Validation Server Operations

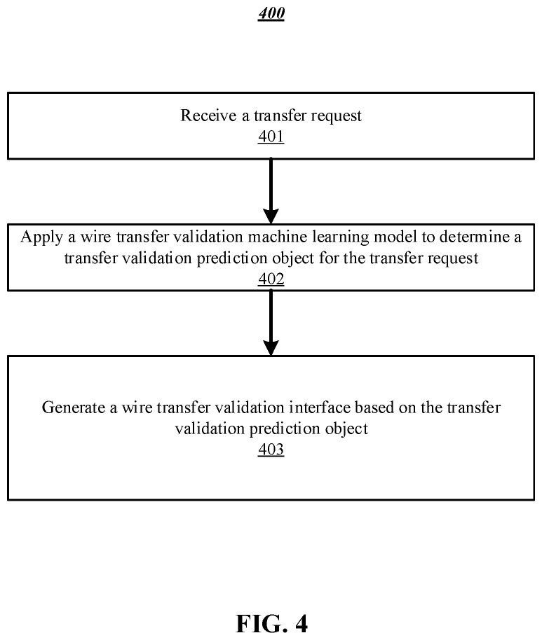

FIG. 4 illustrates a flowchart containing a series of operations for validating a wire transfer. The operations illustrated in FIG. 4 may, for example, be performed by, with the assistance of, and/or under the control of an apparatus (e.g., wire transfer validation server 200), as described above. In this regard, performance of the operations may invoke one or more of processor 202, memory 204, input/output circuitry 206, communications circuitry 208, and/or wire transfer validation circuitry 210.

As shown in operation 401, the wire transfer validation server 200 includes means, such as input/output circuitry 206, communications circuitry 208, or the like, for receiving a transfer request. Such a transfer request may be generated based upon a received request from a client (e.g., user of the wire transfer validation server) who may wish to send a wire transfer from the client to a potential recipient. For example, a user associated with a client device 1101 may input a transfer request via the client device 1101, and the transfer request may be provided to the wire transfer validation server 200, such as via the network 101.

As shown in operation 402, the wire transfer validation server 200 includes means, such as processor 202, wire transfer validation circuitry 210, or the like, for applying a wire transfer validation machine learning model to the determine a transfer validation prediction object associated with the transfer request. In some embodiments, the transfer request may comprise one or more data objects associated with the potential recipient of the wire transfer (e.g., such as the recipient's name, recipient's phone number, recipient's address, recipient's email, recipient's location, recipient's account number, recipient's routing number for the wire transfer, an associated entity of the recipient, and a time with which the transfer request was submitted). In some embodiments, the data objects associated with the potential recipient of the transfer request may be used by the machine learning model to generate a meta score of the transfer request, which is described in further detail below. As described above, in some embodiments, the transfer request may include one or more instances of or data associated with scannable indicia (e.g., a QR code or the like) that may be indicative of a recipient of the transfer request.

In some embodiments, the transfer request may include scannable indicia capable of being read by a computing device via one or more imaging methods, image processing, or the like (e.g., scanning, image capture, etc.). For example, the computing device may process the scannable indicia of a transfer request, extract, parse, and/or collect one or more data objects (e.g., account identifier, recipient identifier, location identifier, time identifier, and/or entity identifier) associated with a potential recipient that provided the scannable indicia to the client.

As shown at operation 403, the apparatus (e.g., wire transfer validation server 200) includes means, such as processor 202, wire transfer validation circuitry 210, or the like, for, once a wire transfer validation machine learning model has determined a transfer validation prediction object associated with the transfer request, generating a wire transfer validation interface based on the transfer validation prediction object. In some embodiments, the wire transfer validation interface may comprise an actionable object (e.g., a GUI of a client device may be configured for user interaction via one or more buttons on a user device and/or one or more buttons indicated on a touch-screen of the client device) to complete a transfer from a user account associated with the transfer request to a recipient account (e.g., a recipient account of the potential recipient for which the wire transfer validation machine learning model processed one or more data objects of personally-identifying information). For example, the recipient account may be identified by analyzing one or more data entries associated with the scannable indicia described above.

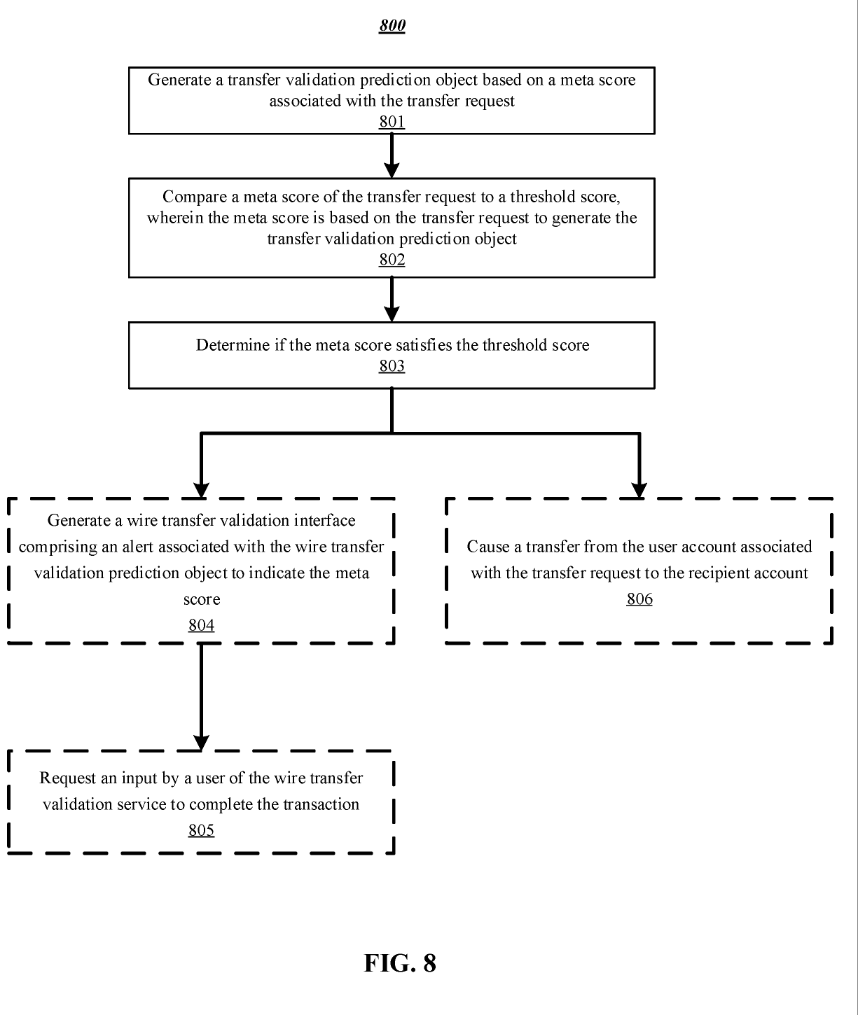

In some embodiments, the transfer validation prediction object may be generated based upon a meta score applied to a threshold score of the wire transfer validation server. For example, FIG. 8 illustrates a flowchart containing a series of operations for validating a wire transfer based upon the generation of a transfer validation prediction object based on a meta score associated with a transfer request. The operations illustrated in FIG. 8 may, for example, be performed by, with the assistance of, and/or under the control of an apparatus (e.g., wire transfer validation server 200), as described above. In this regard, performance of the operations may invoke one or more of processor 202, memory 204, input/output circuitry 206, communications circuitry 208, and/or wire transfer validation circuitry 210.

As shown in operation 801, the wire transfer validation server 200 includes means, such as input/output circuitry 206, communications circuitry 208, or the like, for generating a transfer validation prediction object based on a meta score associated with the received transfer request. Such a meta score may be generated by the wire transfer validation machine learning model using the training identifiers (e.g., score identifier, recipient identifier, account identifier, location identifier, entity identifier, and/or time identifier). The wire transfer validation machine learning model may assess the likelihood of a wire transfer scam based on matching data used to train the wire transfer validation machine learning model and the data objects of the transfer request. For example, if it is determined during training of the wire transfer validation machine learning model that an account number of the account identifier associated with a recipient was previously used in a wire transfer scam (e.g., based upon extracting and parsing of the online and non-online resources), the wire transfer validation machine learning model may assign a higher score identifier to the transfer request based upon the matching account numbers, which may include a matching bank account number and/or matching routing number.

In some embodiments, a recipient identifier may be used to generate a score identifier for the meta score generation. For example, if it is determined during training of the wire transfer validation machine learning model that a recipient name, recipient phone number, recipient email address, or other personally-identifying information of a recipient is associated with a wire transfer scam, the wire transfer machine learning model may assign a higher score identifier to the transfer request based upon the matching personally-identifying information. In some embodiments, the matching of a recipient's phone number for a transfer request to an identified phone number of a recipient previously used in a wire transfer scam may generate a higher weight for the score identifier. For example, when calculating the score identifier, each identifier (e.g., recipient identifier, account identifier, location identifier, entity identifier, and/or time identifier) may be given a score by the wire transfer validation machine learning model based upon the matching of the personally-identifying information of the potential recipient from the transfer request to the identifiers used to train the machine learning model, and once each score has been generated based on each matching between the personally-identifying information and the identifiers by the wire transfer validation machine learning model, the scores may be aggregated to generate a score identifier. Such a score identifier may be stored in a database with the wire transfer validation machine learning model and periodically updated when new transfer requests are received with personally-identifying information matching or not-matching the identifiers (e.g., recipient identifier, account identifier, location identifier, entity identifier, and/or time identifier) of the score identifier.

In some embodiments, the location identifier and a matched location of the potential recipient may be weighted less depending on the radius of the location identifier and the location of the potential recipient. For example, if the location identifier used to train the wire transfer validation machine learning model comprises only the location of a country as a whole, then the matching of the potential recipient's location and/or address to an address within the country may be weighted less than other identifiers (e.g., recipient identifier, account identifier, entity identifier, and/or time identifier). In contrast, if the location identifier used to train the wire transfer validation machine learning model matches a specific home or work address of the potential recipient, the location identifier and associated score may be weighted more heavily than the other identifiers (e.g., recipient identifier, account identifier, entity identifier, and/or time identifier) and their associated scores.

In some embodiments, each of the identifiers and the identifying information (e.g., personally identifying information) of the potential recipient are weighted equally by the wire transfer validation machine learning model. In some embodiments, once the score identifier is generated based upon the identifying information (e.g., personally identifying information) of the potential recipient, the score identifier may be used to generate the meta score. In order to generate the transfer validation prediction object, as shown at operation 801, the meta score of the transfer request is compared to a threshold score and the transfer validation prediction object is generated. As shown at operations 802-803, the meta score of the transfer request is compared to the threshold score to determine if the meta score satisfies the threshold. In embodiments in which the threshold comprises a score, the comparison of whether the meta score satisfies the associated threshold may refer to a comparison of the mathematical value of the meta score with a mathematical value or score of the threshold. As such, satisfaction of the threshold may, in some embodiments, refer to a meta score that fails to exceed (e.g., is less than) the threshold score. In some embodiments in which the meta score does not exceed the threshold score (e.g., satisfies the associated threshold), the transfer validation prediction object may comprise an indication that the wire transfer is valid (e.g., not fraudulent and/or that there is little likelihood of a wire transfer scam). In some embodiments in which the meta score exceeds the threshold score (e.g., fails to satisfy the associated threshold), the transfer validation prediction object may comprise an indication that the wire transfer is likely fraudulent.

In some embodiments, as shown at operations 804-805, the apparatus (e.g., wire transfer validation server 200) includes means, such as processor 202, wire transfer validation circuitry 210, or the like, for, once the meta score has been compared to the threshold score, generating a wire transfer validation interface for rending on a configured GUI or the like (e.g., rendered via the server 200, one or more client devices, one or more recipient devices, etc.). The wire transfer validation interface may comprise an alert associated with the wire transfer validation prediction object to indicate the meta score. In some embodiments, the wire transfer validation interface may comprise an indication that the meta score has not exceeded the threshold score (e.g., satisfies the threshold) and, thus, the wire transfer associated with the transfer request is not likely to be fraudulent. In some embodiments, once the wire transfer validation interface has been rendered on the configured GUI of a client device, the wire transfer validation server 200 may request an input by a user of the wire transfer validation server to complete the wire transfer (i.e., transmit the wire transfer from the client and/or user to the recipient associated with the potential recipient), such as via a selection of an actionable object rendered via the client device in the wire transfer validation interface. In some embodiments, the wire transfer validation interface comprising the requested input by the user to continue with the wire transfer may comprise an indication of a likely fraudulent wire transfer. For example, the wire transfer validation server 200 may indicate that a wire transfer is likely a scam and/or fraudulent but may still allow a user to continue with the wire transfer. In some embodiments, the wire transfer validation interface comprising a requested input by the user to continue with the wire transfer may comprise an indication that the wire transfer is unlikely to be a scam and/or fraudulent. In some embodiments, the wire transfer validation system may require a user and/or client to input a data object comprising a password associated with the user's account for the wire transfer (e.g., a bank account password).

In some embodiments, the wire transfer validation interface may comprise a configured GUI to show the user and/or client “hot-zones” of wire transfer scams and/or fraud. For example, a transfer request for a wire transfer to a recipient in a particular location may comprise a wire transfer validation interface to indicate a hot-zone of this particular location, which may further comprise a map of the particular location highlighted to emphasize the country of this location as a hot-zone of wire transfer fraud (e.g., by color, shading, outlining, etc.). In some embodiments, a configured GUI may show or illustrate examples of scannable indicia that may be associated with one or more “hot-zones” (e.g., physical locations or geographic regions) of wire transfer scams. For example, one example form of scannable indicia (e.g., QR code, barcode, code, etc.) may have a higher likelihood of being associated with a wire transfer scam than another form of scannable indicia.

In some embodiments, when the meta score exceeds a threshold score (e.g., fails to satisfy the associated threshold), the transfer request associated with the meta score may be sorted into a suspicious bucket or dataset of the wire transfer validation machine learning model, wherein the suspicious dataset may be a database comprising transfer requests determined to be a scam and/or fraudulent. In some embodiments, if the meta score does not exceed a threshold score (e.g., satisfies the associated threshold), the transfer request associated with the meta score may be sorted into a genuine bucket or dataset for future transmission of the wire transfer by the user and/or client of the wire transfer validation server 200. In some embodiments, the wire transfer may be automatically transmitted when the meta score is determined to not have exceeded the threshold score (e.g., when the meta score satisfies the associated threshold).

In some embodiments, the threshold score may be predetermined by the wire transfer validation server 200 based upon one or more score identifiers used to train the wire transfer validation machine learning model(s). For example, once a cluster of score identifiers comprising a similar amount and/or number are determined to comprise data indicative of a fraudulent wire transfer, the wire transfer validation server 200 may determine the threshold score to be an amount within the cluster of score identifiers (e.g., such as an average, a mean, or a median).

In some embodiments, and as shown at operation 806, the apparatus (e.g., wire transfer validation server 200) includes means, such as processor 202, wire transfer validation circuitry 210, or the like, for, once the meta score has been compared to the threshold score and it is determined whether the meta score fails to exceed the threshold score at operation 803 (e.g., satisfies the associated threshold), transmitting the real-time transfer of the wire transfer automatically without input by the user. For example, and at operation 806, the wire transfer may be transmitted in real-time (e.g., immediately after it is determined by the wire transfer validation server that the meta score satisfies the threshold score) from a user account (e.g., the user and/or client of the wire transfer validation server) associated with the wire transfer request to a recipient account, such as indicated by the scannable indicia associated with the transfer request.

It is to be understood the implementations are not limited to particular systems or processes described which may, of course, vary. It is also to be understood that the terminology used herein is for the purpose of describing particular implementations only and is not intended to be limiting. As used in this specification, the singular forms “a”, “an” and “the” include plural referents unless the content clearly indicates otherwise. Thus, for example, references to “an image” includes a combination of two or more images and references to “a graphic” includes different types and/or combinations of graphics.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate form the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A computer-implemented method for wire transfer validation, the computer-implemented method comprising:
continuously training a wire transfer validation machine learning model based at least on one or more report data objects extracted from a set of wire transfer reports, wherein continuously training the wire transfer validation machine learning model includes:
updating at least one score identifier associated with the wire transfer validation machine learning model based on a newly received wire transfer report;
receiving a wire transfer request, wherein the wire transfer request comprises one or more data entries associated with scannable indicia indicative of a recipient of the wire transfer request;
applying, for the wire transfer request, the wire transfer validation machine learning model to determine, as output of the wire transfer validation machine learning model, a transfer validation prediction object for the wire transfer request, wherein the transfer validation prediction object is associated with a score identifier comprising an aggregate of scores for a plurality of personally-identifiable information (PII) elements of the recipient of the wire transfer request, and wherein determining the transfer validation prediction object comprises:
determining, via the wire transfer validation machine learning model, whether at least one PII element of the recipient of the wire transfer request is linked to a wire transfer scam, and
increasing or decreasing, via the wire transfer validation machine learning model, a value of the score identifier in response to the determination;
generating a wire transfer validation interface that indicates a likelihood of the wire transfer request involving fraudulent activity based on the transfer validation prediction object and comprises an actionable object configured to complete a wire transfer from a user account associated with the wire transfer request to a recipient account of the recipient as indicated by the scannable indicia of the wire transfer request;
causing presentation of the wire transfer validation interface; and
causing a wire transfer from the user account to the recipient account in response to a selection of the actionable object via the wire transfer validation interface.

2. The computer-implemented method according to claim 1, further comprising:
training the wire transfer validation machine learning model using a training protocol comprising:
collecting a set of wire transfers from a database over a first time period;
extracting one or more identifiers from the set of wire transfers to create a training set of wire transfers, wherein the training set of wire transfers comprises the at least one score identifier based on at least one of a recipient identifier, a location identifier, or an account identifier; and
training the wire transfer validation machine learning model using the training set of wire transfers.

3. The computer-implemented method according to claim 2, further comprising:
training the wire transfer validation machine learning model using the training protocol comprising:
collecting a second set of wire transfers from the database over a second time period;
extracting one or more identifiers from the second set of wire transfers to create a second training set of wire transfers; and
training the wire transfer validation machine learning model using the second training set of wire transfers.

4. The computer-implemented method according to claim 2, further comprising:
applying a meta score to the transfer validation prediction object associated with the wire transfer request.

5. The computer-implemented method according to claim 4, further comprising:
assigning the meta score associated with the wire transfer request to the score identifier of the training set of wire transfers to create an updated score identifier associated with at least one of the recipient identifier, the location identifier, or the account identifier.

6. The computer-implemented method according to claim 4, further comprising:
modifying, in response to a determination that the meta score satisfies a threshold score, the wire transfer validation interface to provide an alert associated with the transfer validation prediction object to indicate the meta score and request an input of a user associated with the user account to complete the wire transfer request.

7. The computer-implemented method according to claim 2, further comprising:
collecting the set of wire transfer reports from one or more report databases;
extracting the one or more report data objects from the set of wire transfer reports; and
parsing the one or more report data objects using a natural language processor (NLP) to determine the score identifier.

8. The computer-implemented method according to claim 4, further comprising:
comparing the meta score of the transfer validation prediction object with a threshold score, wherein the meta score is determined by the transfer validation prediction object associated with the wire transfer request; and
determining that the meta score satisfies the threshold score.

9. The computer-implemented method according to claim 8, further comprising:
causing, in response to the determination that the meta score satisfies the threshold score, the wire transfer from the user account associated with the wire transfer request to the recipient account as indicated by the scannable indicia of the wire transfer request.

10. An apparatus for wire transfer validation, the apparatus comprising at least one processor and at least one memory including program code, the at least one memory and program code configured to, with the at least one processor, cause the apparatus to:
continuously train a wire transfer validation machine learning model based at least on one or more report data objects extracted from a set of wire transfer reports, wherein continuously training the wire transfer validation machine learning model includes:
updating at least one score identifier associated with the wire transfer validation machine learning model based on a newly received wire transfer report;
receive a wire transfer request, wherein the wire transfer request comprises one or more data entries associated with scannable indicia indicative of a recipient of the wire transfer request;
for the wire transfer request, apply the wire transfer validation machine learning model to determine, as output of the wire transfer validation machine learning model, a transfer validation prediction object for the wire transfer request, wherein the transfer validation prediction object is associated with a score identifier based on an aggregate of scores for a plurality of personally-identifiable information (PII) elements of the recipient of the wire transfer request, and wherein determining the transfer validation prediction object comprises:
determining, via the wire transfer validation machine learning model, whether at least one PII element of the recipient of the wire transfer request is linked to a wire transfer scam, and
increasing or decreasing, via the wire transfer validation machine learning model, a value of the score identifier in response to the determination;
generate a wire transfer validation interface that indicates a likelihood of the wire transfer request involving fraudulent activity based on the transfer validation prediction object and comprises an actionable object configured to complete a wire transfer from a user account associated with the wire transfer request to a recipient account of the recipient as indicated by the scannable indicia of the wire transfer request;
cause presentation of the wire transfer validation interface; and
cause a wire transfer from the user account to the recipient account in response to a selection of the actionable object via the wire transfer validation interface.

11. The apparatus according to claim 10, wherein the at least one memory and program code are configured to, with the at least one processor, cause the apparatus to:
train the wire transfer validation machine learning model using a training protocol in that the apparatus:
collects a set of wire transfers from a database over a first time period;
extracts one or more identifiers from the set of wire transfers to create a training set of wire transfers, wherein the training set of wire transfers comprises the at least one score identifier based on at least one of a recipient identifier, a location identifier, or an account identifier; and
trains the wire transfer validation machine learning model using the training set of wire transfers.

12. The apparatus according to claim 11, wherein the at least one memory and program code are configured to, with the at least one processor, cause the apparatus to:
train the wire transfer validation machine learning model using the training protocol in that the apparatus:
collects a second set of wire transfers from the database over a second time period;
extracts one or more identifiers from the second set of wire transfers to create a second training set of wire transfers; and
trains the wire transfer validation machine learning model using the second training set of wire transfers.

13. The apparatus according to claim 11, wherein the at least one memory and program code are configured to, with the at least one processor, cause the apparatus to apply a meta score to the transfer validation prediction object associated with the wire transfer request.

14. The apparatus according to claim 13, wherein the at least one memory and program code are configured to, with the at least one processor, cause the apparatus to:
assign the meta score associated with the wire transfer request to the score identifier of the training set of wire transfers to create an updated score identifier associated with at least one of the recipient identifier, the location identifier, or the account identifier.

15. The apparatus according to claim 13, wherein the at least one memory and program code are configured to, with the at least one processor, cause the apparatus to:
modify, in response to the determination that the meta score satisfies a threshold score, the wire transfer validation interface to provide an alert associated with the transfer validation prediction object to indicate the meta score and request an input of a user associated with the user account to complete the wire transfer request.

16. The apparatus according to claim 11, wherein the at least one memory and program code are configured to, with the at least one processor, cause the apparatus to:
collect the set of wire transfer reports from one or more report databases;
extract the one or more report data objects from the set of wire transfer reports; and
parse the one or more report data objects using a natural language processor (NLP) to determine the score identifier.

17. The apparatus according to claim 13, wherein the at least one memory and program code are configured to, with the at least one processor, cause the apparatus to:
compare the meta score of the transfer validation prediction object with a threshold score, wherein the meta score is determined by the transfer validation prediction object associated with the wire transfer request; and
determine that the meta score satisfies the threshold score.

18. The apparatus according to claim 17, wherein the at least one memory and program code are configured to, with the at least one processor, cause the apparatus to:
cause, in response to the determination that the meta score satisfies the threshold score, the wire transfer from the user account associated with the wire transfer request to the recipient account as indicated by the scannable indicia of the wire transfer request.

19. The apparatus according to claim 17, wherein the at least one memory and program code are configured to, with the at least one processor, cause the apparatus to apply the meta score to the wire transfer validation machine learning model to determine one or more subsequent transfer validation predictions.

20. A computer program product comprising at least one non-transitory computer-readable storage medium having computer readable program code thereon that, in execution with at least one processor, configures the computer program product for:
continuously training a wire transfer validation machine learning model based at least on one or more report data objects extracted from a set of wire transfer reports, wherein continuously training the wire transfer validation machine learning model includes:
updating at least one score identifier associated with the wire transfer validation machine learning model based on a newly received wire transfer report;
receiving a wire transfer request, wherein the wire transfer request comprises one or more data entries associated with scannable indicia indicative of a recipient of the wire transfer request;
applying, for the wire transfer request, the wire transfer validation machine learning model to determine, as output of the wire transfer validation machine learning model, a transfer validation prediction object for the wire transfer request, wherein the transfer validation prediction object is associated with a score identifier based on an aggregate of scores for a plurality of personally-identifiable information (PII) elements of the recipient of the wire transfer request, and wherein determining the transfer validation prediction object comprises:
determining, via the wire transfer validation machine learning model, whether at least one PII element of the recipient of the wire transfer request is linked to a wire transfer scam, and
increasing or decreasing, via the wire transfer validation machine learning model, a value of the score identifier in response to the determination;
generating a wire transfer validation interface that indicates a likelihood of the wire transfer request involving fraudulent activity based on the transfer validation prediction object and comprises an actionable object configured to complete a wire transfer from a user account associated with the wire transfer request to a recipient account of the recipient as indicated by the scannable indicia of the wire transfer request;
causing presentation of the wire transfer validation interface; and
causing a wire transfer from the user account to the recipient account in response to a selection of the actionable object via the wire transfer validation interface.
